(19) United States
(12) Patent Application Publication
(10) Pub. No.: US 2024/0421739 A1
(43) Pub. Date: Dec. 19, 2024

(54) POWER SUPPLY SYSTEM FOR A BEARING CONTROLLER

(71) Applicant: L'Air Liquide, Socíété Anonyme Pour I'Etude et I'Exploitation des Procêdés Georges Claude, Paris (FR)

(72) Inventors: Eric FESSLER, Sassenage (FR); Fabien DURAND, Voreppe (FR)

(21) Appl. No.: 18/293,125

(22) PCT Filed: Jul. 21, 2022
(86) PCT No.: PCT/EP2022/070452

§ 371 Date: Sep. 3, 2024

(30) Foreign Application Priority Data
Jul. 29, 2021 (FR) FR2108233

(51) Int. Cl. H02P 25/022; H02P 23/00

(52) U.S. Cl. CPC H02P 25/022; H02P 23/00

(57) ABSTRACT

A system for supplying power to a magnetic bearing controller of a permanent magnet synchronous motor comprising:
a first power supply module configured to be connected to a power grid and to supply voltage to the magnetic bearing controller,
a second power supply module configured to supply voltage to the magnetic bearing controller, the voltage of the second power supply module being drawn from the synchronous motor,
a device for selecting the first power supply module or the second power supply module for supplying a voltage to the magnetic bearing controller,
   wherein
the second power supply module is configured to deliver, in a nominal operating mode, a voltage lower than the voltage delivered by the first power supply module,
the second power supply module is connected in parallel with the first power supply module and upstream of the magnetic bearing controller,

The selection device is configured to select the power supply module delivering the higher voltage to the magnetic bearing controller.

### CROSS REFERENCE TO RELATED APPLICATIONS

This application is a 371 of International Application No. PCT/EP2022/070452, filed Jul. 21, 2022, which claims priority to French Patent Application No. 2108233, filed Jul. 29, 2021, the entire contents of which are incorporated herein by reference.

### BACKGROUND

### Technical Field of the Invention

The invention relates to a power supply system comprising a first power supply module and a second back-up power supply module for supplying power to a magnetic bearing controller of a permanent magnet synchronous motor. More particularly, the second power supply module supplies power to the magnetic bearing controller by draw-off.

### Prior Art

Conventionally, it is known to supply power continuously to a magnetic bearing controller of a permanent magnet synchronous motor. The loss of a power supply to magnetic bearings is managed by using ball bearings with the function of supporting the shaft of the rotating machine if the power supply to the magnetic bearings fails. These ball bearings are often unable to withstand one or more drops of the shaft when the magnetic bearings lose their power supply: their service life may be reduced or they may be damaged.

If a magnetic bearing controller is supplied with a single power supply module, the magnetic bearing controller ceases to be operational if the power supply fails. The back-up ball bearing of the magnetic bearing, which is no longer controlled by the controller, is then at risk of damage following a temporary stoppage of the motor and the freewheel rotation of the motor shaft. Thus the service life of back-up bearings is greatly reduced when there is a power failure.

To overcome this problem, it is known to use a second power supply module, this second power supply module forming a back-up power supply module if there is a failure of the power supply to the magnetic bearing controller by the first power supply module.

Conventionally, a magnetic bearing controller of a permanent magnet synchronous motor is supplied by a first power supply module, for operation in nominal mode (that is to say, when the first power supply module is operating normally), and by a second back-up power supply module if there is a power failure in the first power supply module.

It is known to use one or more batteries as a second power supply module.

However, the use of batteries causes a number of problems. Firstly, batteries are bulky, resulting in large overall dimensions. The batteries also have a considerable weight.

Furthermore, the batteries need a dedicated space for their installation, which must provide ventilation, because of possible emissions of gas from the batteries, and must maintain an ambient temperature such that the risks of thermal runaway are avoided. Batteries require electronic charging devices which increase the cost of the solution and make it less flexible, since charged batteries become a prerequisite for the safe use of the rotating machine, while the charging device must also ensure that the batteries do not become totally discharged, which would cause them to enter what is known as a deep discharge state that would adversely affect their correct operation in the future. Thus batteries require regular maintenance and, because of their limited service life, must be changed over time, with a resulting economic impact.

One object of the present invention is to overcome some or all of the drawbacks of the prior art, particularly by providing a back-up power supply to the magnetic bearing controller.

### SUMMARY

For this purpose, the present invention proposes a power supply system for a magnetic bearing controller of a permanent magnet synchronous motor, comprising:
a first power supply module, configured to be connected to a power grid and to supply voltage to the magnetic bearing controller,
a second power supply module, configured to supply voltage to the magnetic bearing controller, the voltage of the second power supply module being drawn from the synchronous motor,
a device for selecting the first power supply module or the second power supply module for supplying voltage to the magnetic bearing controller,
wherein
the second power supply module is configured to deliver, in nominal operating mode, a voltage below the voltage delivered by the first power supply module,
the second power supply module is connected in parallel with the first power supply module and upstream of the magnetic bearing controller,

The selection device is configured to select the power supply module delivering the higher voltage to the magnetic bearing controller.

Advantageously, such a system enables a back-up power supply to be delivered to a magnetic bearing controller without requiring the use of consumables that would need maintenance and replacement. A battery needs maintenance and must be replaced over time, while also being bulky and heavy.

A power supply system according to the invention is simple, reliable, robust, maintenance-free and inexpensive.

By drawing the voltage from the synchronous motor, it is possible to supply the voltage to the magnetic bearing controller in a short time interval, without the need for a power supply module independent of the first power supply module and the synchronous motor.

When the second power supply module draws the voltage from the synchronous motor, the magnetic bearing controller can be supplied until the ball bearings of the magnetic bearing, called “catcher bearings”, can take over and receive the synchronous motor shaft at a low enough speed to ensure that the back-up ball bearings are never subject to premature wear or damage. The motor shaft drops onto the ball bearings of the magnetic bearing until the motor finally comes to a halt, without causing any damage to the magnetic bearing.

The power supply system according to the invention may also have one or more of the following characteristics, considered individually or in all feasible combinations:
the selection device comprises a voltage rectifier element; and/or
the second power supply module is configured to be supplied with voltage by the motor in nominal operating mode; and/or
the second power supply module is configured to be supplied with voltage by the motor when the motor is freewheel mode, the motor acting as a generator; and/or
the second power supply module is configured to be supplied with voltage by the motor as follows:
with the aid of a speed controller, in nominal operating mode, or
by the motor acting as a generator when in freewheel mode; and/or
the selection device comprises at least two ORing diodes, the first ORing diode being positioned downstream of the first power supply module, and the second ORing diode being positioned downstream of the second power supply module.
the first and second ORing diodes being arranged in parallel; and/or
the first power supply module and/or the second power supply module comprises a transformer; and/or
the voltage accepted by the magnetic bearing controller is between 70 V DC and 800 V DC, or preferably between 100 V DC and 750 V DC; and/or
the second power supply module is configured to deliver a minimum voltage of between 70 V DC and 120 V DC, preferably 100 V DC, to the magnetic bearing controller, at a frequency of between 60 Hz and 100 Hz, preferably 80 Hz; and/or
the power supply system comprises a device for monitoring the voltage delivered by the power supply modules; and/or
the power supply system comprises, downstream of the first power supply module and the second power supply module, a capacitive filter for smoothing the voltage; and/or
the capacitive filter forms an energy storage means.

The present invention also relates to a cycle gas compression system of a refrigeration system and/or a gas liquefaction system, comprising a power supply system according to any of the embodiments described.

The present invention also relates to a method for supplying power to a magnetic bearing controller of a permanent magnet synchronous motor comprising a step of selecting, by means of a selection device, a power supply module delivering the higher voltage to supply the magnetic bearing controller,
the selection being made between:
a first power supply module, configured to be connected to a power grid and to supply voltage to the magnetic bearing controller, and
a second power supply module, connected in parallel with the first power supply module, the voltage delivered by the second power supply module being drawn from the synchronous motor,
the second power supply module delivering, in a nominal operating mode, a voltage below the voltage delivered by the first power supply module,
a step of delivering a power supply in which the magnetic bearing controller is supplied by the power supply module selected by the selection device.

Advantageously, such a power supply method makes it possible to maintain a voltage supply to the magnetic bearing controller and avoid damage to one of the bearings if the power supply to the magnetic bearing controller is lost.

The second power supply module, drawing the voltage from the synchronous motor, may be used to supply the magnetic bearing controller until the ball bearings of the magnetic bearing, called “catcher bearings”, can take over and receive the synchronous motor shaft. The motor shaft drops onto the ball bearings of the magnetic bearing until the motor finally comes to a halt, without causing any damage to the magnetic bearing.

The power supply method according to the invention may also have one or more of the following characteristics, considered individually or in all feasible combinations:
the synchronous motor acts as a generator when it is in freewheel mode; and/or
the second power supply module supplies the magnetic bearing controller for a period of between 1 s and 60 s, or more particularly between 5 s and 30 s; and/or
the second power supply module supplies the magnetic bearing controller, and the voltage delivered to the magnetic bearing controller decreases over time until a minimum voltage is reached; and/or
the minimum voltage delivered to the magnetic bearing controller is between 70 V DC and 120 V DC, and has a frequency of between 60 Hz and 100 Hz; and/or
the supply of power to the magnetic bearing controller by the second power supply module is followed by a rest period in which the magnetic bearing controller is not supplied by the second power supply module; and/or
the rest period is between 30 s and 160 s, or more particularly between 100s and 140 s, or more precisely 120 s.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic electrical representation of a control system according to an embodiment of the invention,

FIG. 2 is a representation of the change in the voltage delivered by the first and the second power supply modules when the first power supply module fails,

FIG. 3 shows a graph of the variation of the power supply provided by the second power supply module,

FIG. 4 shows a flow diagram defining the power supply method according to the invention.

It should be noted that these drawings have the sole purpose illustrating the text of the description, and do not constitute any kind of limit on the scope of the invention.

To clarify the terms “upstream” and “downstream” in relation to the arrangement of the electrical components, the arrangement of these components is defined according to the direction of the current.

For example, a second electrical element arranged downstream of a first electrical element is farther from the positive terminal of the voltage supply module than the first element.

### DETAILED DESCRIPTION OF THE PREFERRED EMBODIMENTS

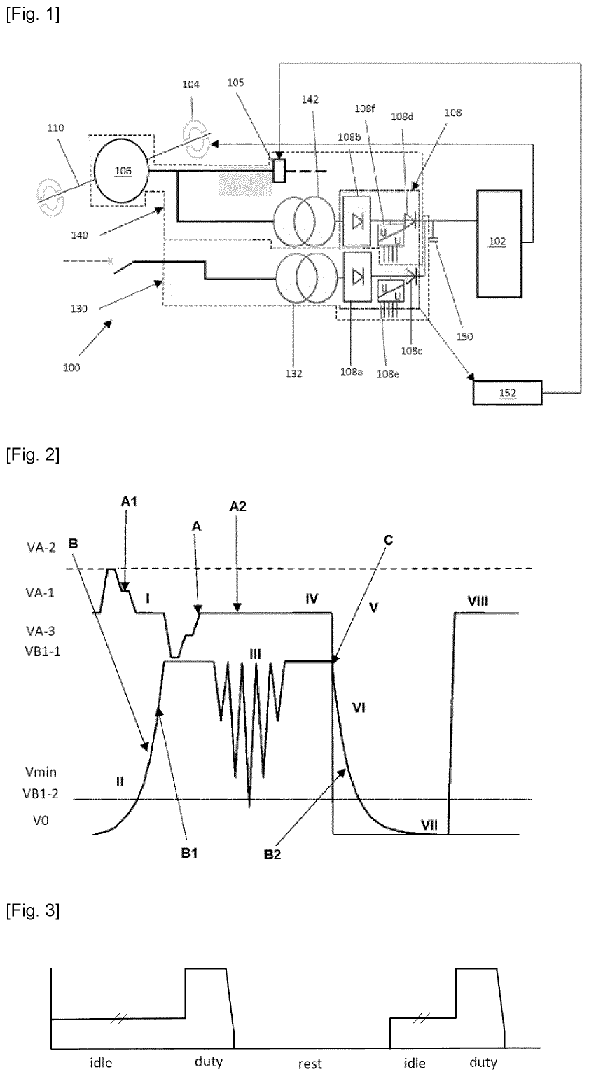

As shown in FIG. 1, the invention relates to an electrical circuit of a power supply system 100, configured to supply power to a magnetic bearing controller 102 of a synchronous motor 106. The bearing controller 102 controls the voltage supply to the magnetic bearings 104.

The power supply system comprises a first power supply module 130 and a second power supply module 140. The power supply system 100 further comprises a selection device 108. The selection module selects the first or second power supply module 130, 140 to supply a voltage to the magnetic bearing controller 102.

In one embodiment, the first power supply module 130 is three-phase.

In one embodiment, the second power supply module 140 is three-phase. The first power supply module 130 is connected to a power grid.

The second power supply module 140 is connected to the synchronous motor 106, and draws the voltage from said motor.

When the synchronous motor operates normally, the second power supply module is supplied by a speed controller 105. The speed controller 105 controls the rotation of the synchronous motor 106 by adjusting the voltage and frequency of the power supply. The power supply is delivered to the motor by the speed controller 105.

When the synchronous motor 106 is in freewheel mode, it acts as a generator and supplies a voltage to the second power supply module.

The first power supply module 130 and the second power supply module 140 are arranged electrically in parallel in the electrical circuit of the power supply system 100, upstream of the magnetic bearing controller 102. In other words, the first power supply module 130 and the second power supply module 140 may be connected electrically in parallel to the same terminal or input of the electrical circuit of the power supply system 100.

The second power supply module is configured to deliver, in a normal operating mode, a voltage that is lower than the voltage delivered by the first power supply module.

The expression “in nominal operating mode” is to be contrasted with the expression “in degraded mode”, and corresponds to the normal operating mode of the power supply system 100, without any failure of the first power supply module 130.

In nominal operating mode, the voltage delivered by the first power supply module 130 is higher than that delivered by the second power supply module 140.

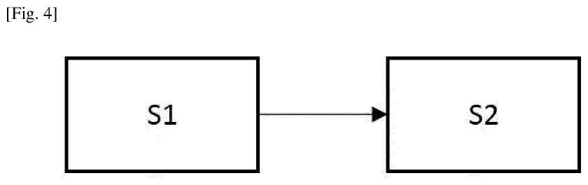

The selection device 108 is configured to select, in a selection step S1, the power supply module 130, 140 which is to supply a voltage to the magnetic bearing controller 102 in the power supply delivery step S2 (FIG. 4). The power supply module 130, 140 delivering the higher voltage is selected, in the selection step S1, by the selection device 108.

In one embodiment, the selection device 108 may comprise one or more electromechanical and/or electrical and/or semiconductor contacts.

In one embodiment, the selection device 108 may comprise a voltage rectifier element 108a, 108b in the first power supply module or the second power supply module, respectively. Such a type of selection device allows a passive selection of the higher voltage delivered by the first or the second power supply module.

In one embodiment, the selection device 108 may comprise a first and a second voltage rectifier element 108a, 108b. The first voltage rectifier element 108a is placed downstream of the first power supply module 130. The second voltage rectifier element 108b is placed downstream of the second power supply module 140. The first and second rectifier elements are connected in parallel in the electrical circuit.

The voltage rectifier elements 108a, 108b allow an alternating voltage to be rectified and made into a DC voltage.

In one embodiment, the selection device 108 comprises two diodes 108c, 108d, placed downstream of the two rectifier elements 108a, 108b respectively. In a more particular embodiment, the diodes 108c, 108d are ORing diodes.

In one embodiment, the first power supply module and the second power supply module each comprise a respective voltage transducer 108e, 108f located between the rectifier element 108a, 108b and the diode 108c, 108d.

The voltage Vcp accepted by the bearing controller 102 is between a voltage Vcp_min and a voltage Vcp_max.

For example, the voltage Vcp_min may be between 50 V DC and 120 V DC, or preferably between 70 V DC and 100 V DC. In this example, Vcp_max is between 750 V DC and 850 V DC, or preferably between 750 V DC and 800 V DC.

In one example, the first power supply module 130 is supplied from a power grid. The voltage of the power grid may be 400 V AC, for example. The first power supply module 130 may not include a transformer, if the alternating voltage supplied by the power grid is considered to vary by about ±20%. The range of voltage Valim1 supplied by the first power supply module 130 is then between a voltage Valim1_min and a voltage Valim1_max.

With reference to the previous example, the range of voltage supplied by the first power supply module 130 is between 300 V AC and 500 V AC, preferably 320 V AC and 480 V AC, when the power supply system is operating in nominal operating mode. That is to say, in the absence of any failure of the first power supply module 130.

In the same example, in nominal operating mode, for the same input voltage in the first power supply module 130, the voltage Valim2_nom supplied by the second power supply module 140, drawn from the synchronous motor 106 via the speed controller 105, is between a voltage Valim2_nom_min and a voltage Valim2_nom_max.

Valim2 may, for example, be between 0 V AC and 600 V AC.

Additionally, in degraded mode, when the first power supply module 130 suffers a failure, the voltage Valim2_deg supplied by the second power supply module 140, drawn from the synchronous motor 106 acting as a generator, is between a value of Valim2_deg_min and Valim2_deg_max, where the value of Valim2_deg_min is greater than the value of Valim2_nom_min. The minimum voltage Valim2_deg_min must be greater than 0 to enable the bearing controller 102 to be powered.

For example, the value of Valim2_deg is between 100 V AC and 600 V AC.

Thus the voltage Valim2_nom, Valim2_deg supplied by the second power supply module 140 reaches, in nominal or degraded operating mode, a maximum voltage Valim2_nom_max, Valim2_deg_max that is greater than the acceptable maximum voltage for the bearing controller 102 Vcp_max, for example 560 V AC.

Furthermore, for operation in nominal operating mode (where there is no failure of the first power supply module 130), the maximum voltage Valim2_nom_max supplied by the second power supply module 140 may be greater than the maximum alternating voltage Valim1_max supplied by the first power supply module 130. The selection device 108 would then select the second power supply module 140, as long as the voltage Valim2_nom drawn from the synchronous motor 106 remains greater than the voltage Valim1 supplied by the first power supply module 130.

This is not a preferred embodiment. In fact, in nominal operating mode, it is desirable for the voltage supply to the bearing controller 102 to be provided by the first power supply module 130, connected to the power grid, rather than by the second power supply module 140, which acts as a back-up power source, drawing its voltage from the synchronous motor 106.

In a preferred embodiment, at least the first power supply module 130 or the second power supply module 140 comprises a transformer 132, 142. Preferably, the first power supply module 130 and the second power supply module 140 each comprise a respective transformer 132, 142.

In one embodiment, the transformers 132, 142 are three-phase transformers.

In a preferred embodiment, the first power supply module 130 comprises a transformer 132 and the second power supply module 140 comprises a transformer 142.

The transformer 132 has a transformation ratio ranging from a minimum transformation value T1_min to a maximum transformation value T1_max.

For example, T1_min is equal to 1.01, more particularly 1.015, or more particularly 1.1. For example, T1_max is equal to 2, more particularly 1.5, or more particularly 1.3.

The transformer 132, having a transformation ratio of more than 1, enables the range of values of Valim1 to be raised. At the output of the transformer, the voltage Valim1T is between Valim1T_min and Valim1T_max. Valim1T_min is greater than Valim1_min, and Valim1T_max is greater than Valim1_max.

For example, for a transformation ratio between 1.1 and 1.3, and for a power grid supply voltage of 400 V AC, the voltage Valim1T at the output of the transformer 132, supplied to the bearing controller 102, has a minimum voltage Valim1T_min of between 420 V AC and 460 V AC and a maximum voltage Valim1T_max of between 500 V AC and 540 V AC. In this embodiment, the voltage Valim1T can oscillate between 350 V AC and 560 V AC, corresponding to a DC voltage of between 475 V DC and 750 V AC.

Therefore, in the preceding example, by using a transformer 132 with a transformation ratio of more than 1 in the first power supply module 130, the maximum voltage Valmi1_max delivered by the first power supply module 130 can be increased to 560 V AC.

Advantageously, the transformation ratio of the transformer 132 is chosen so that, in nominal operating mode, the voltage supply Valim1T delivered by the first power supply module 130 is always greater than that delivered by the second power supply module 140 (as shown in FIG. 2, where the curve A, corresponding to the voltage delivered by the first power supply module 130, is above the curve B, corresponding to the voltage delivered by the second power supply module 140 in the section B1 corresponding to operation in nominal operating mode).
for the second power supply module 140, the transformation ratio of the transformer 142 is between a minimum transformation value T2_min and a maximum transformation value T2_max.

For example, T2_min is equal to 0.1, or more particularly 0.2, or more particularly 0.5. For example, T2_max is equal to 0.99, more particularly 0.8, or more particularly 0.7.

For example, for such a transformation ratio, in nominal operating mode, the voltage Valim2T_nom delivered by the second power supply module 140 at the output of the transformer 142 has a minimum voltage value Valim2T_nom_min and a maximum voltage value Valim2T_nom_max.

For example, the voltage Valim2T_nom is between 0 V AC and 300 V AC, corresponding to a DC voltage of between 0 and 440 V DC.

By using a transformer 142 having a transformation ratio of less than 1 in the second power supply module 140, it is possible, in the example, to lower the maximum voltage Valim2_nom_max delivered by the second power supply module 140 to 300 V AC, which is below the lower limit of voltage delivered by the first power supply module 130, which is 350 V AC.

The presence of the transformer 142, having a transformation ratio of less than 1, makes it possible to reduce the range of voltage Valim2T_nom delivered by the second voltage module.

In the present example, in nominal operating mode, after the incorporation of the transformers 132, 142, the maximum voltage Valim2T_nom_max delivered by the second power supply module 140 is lower than the minimum voltage Valim1T_min delivered by the first power supply module 130. This ensures that, in nominal operating mode, after the current has flowed through the rectifier elements 108a, 108b, the bearing controller 102 is supplied solely by the first power supply module 130 connected to the power grid.

The presence of the transformers 132, 142 not only ensures that power is supplied via the first power supply module 130 in nominal operating mode, but also enables a maximum voltage Valim1T_max to be delivered to the bearing controller 102, this maximum voltage being smaller than or equal to the maximum voltage Vcp_max accepted by said controller.

If there is a failure in the power supply via the first module 130, the voltage Valim2T_deg delivered by the second power supply module 140, at the output of the transformer 142 (which has the transformation ratio stated in the above example) is between a minimum voltage value Valim2T_deg_min and a maximum voltage value Valim2T_deg_max.

For example, the minimum voltage value Valim2T_deg_min is between 70 V AC and 80 V AC. The maximum voltage value Valim2T_deg_max is between 540 V AC and 560 V AC, corresponding to a DC voltage of between 100 V DC and 750 V DC.

Thus the voltage Valim2T_deg delivered to the bearing controller 102 by the second power supply module 140, using the synchronous motor 106 operating as a generator, is within the range of voltage values Vcp accepted by the bearing controller 102 (between 70 V AC and 560 V AC, for example).

Thus, when the transformers 132, 142 are present, the voltage delivered by the first power supply module 130 or the second power supply module 140 is accepted by the bearing controller 102.

In a particular embodiment, the power supply system 100 comprises a device 152 for monitoring the voltage delivered by at least the first power supply module 130, and preferably by the first and the second power supply modules 130, 140.

The monitoring device 152 is connected to the selection device 108.

The monitoring device 152 can check the voltage of the first and/or second power supply modules 130, 140. The voltage is checked by acquiring the voltage measured by the voltage transducers 108e and 108f.

The monitoring device 152 enables a warning to be given of a failure in the first power supply module, and possibly in the second power supply module.

The monitoring device 152 is connected to a checking and control device configured to manage the failure modes of the first power supply module 130.

The monitoring device 152 may use a PLC system for controlling the voltage of the first and/or the second power supply modules 130, 140.

The monitoring device 152 may control the speed controller 105 to regulate the power delivered by the speed controller 105 to the asynchronous motor.

In a particular embodiment, the power supply system comprises, downstream of the first power supply module 130 and the second power supply module 140, a capacitive filter 150 forming an energy storage means.

The capacitive filter may be formed by a capacitor, an inductor, or a metal oxide varistor.

Advantageously, because of the energy storage provided, the capacitive filter can allow a more flexible transition between the power supply provided by the first power supply module 130, in nominal operating mode, and the power supply provided by the second power supply module 140, if the first power supply module 130 fails.

For a better understanding of the invention, reference should be made to FIG. 2, which shows how the voltage supply delivered by the first power supply module 130 (curve A) supplements that delivered by the second power supply module 140 (curve B, the portion B1 defining the portion of curve B in nominal operating mode and portion B2 defining the portion of curve B in degraded mode, following a failure of the first power supply module 130). FIG. 2 also shows a return to the normal state after the failure of the first module has been remedied.

The reference I in FIG. 2 indicates that, in nominal operating mode, voltage curve A corresponds to the first power supply module 130. Curve B1 corresponds to the curve of the voltage supplied by the second power supply module 140.

The voltage of curve A may be stabilized at a value VA-1 or may oscillate between the voltage values VA-2 and VA-3.

In nominal operating mode, the voltage of curve B1 may oscillate between the voltage values VB1-1 and VB1-2.

For example, VB1-1 is equal to Valim2T_nom_max.

In nominal operating mode, the value of the voltage of curve B1, between VB1-1 and VB1-2, is constantly below the minimum value of curve A, which is between the values VA-3 and VA-2.

For example, VA-2 is equal to Valim1T_max, and/or VA-3 is equal to Valim1T_min.

This corresponds to the second power supply module 140 being in the “idle” state shown in FIG. 3, this term denoting a state in which the second power supply module 140 draws voltage from the synchronous motor 106, but does not supply the bearing controller 102. This is the case, regardless of whether the voltage supply to the first power supply module 130 undergoes transient variations between the values VA-2 and VA-3 or remains permanently at a value VA-1. The selection device 108 therefore selects only the first power supply module 130 to supply voltage to the bearing controller 102.

The reference II indicates the start of the power supply to the second power supply module 140, after the first power supply module 130 has been supplied by the synchronous motor for a first period of time. The voltage delivered by the second power supply module 140 changes from V0, a zero voltage, to a voltage varying between VB1-1 and VB1-2.

The reference III indicates that, even when the second power supply module 140 is supplied with sufficient power to deliver a power supply to the bearing controller 102, the voltage peaks of curve B1, having a value VB1-1, are constantly lower than the voltage delivered by the first power supply module 130, in nominal operating mode.

The reference IV indicates the failure of the first power supply module 130, and the sudden fall of the voltage delivered by this power supply module to the voltage V0, as revealed by an almost vertical voltage drop shown in Curve A.

The reference V indicates the point on the graph after curve A of the first power supply module 130 intersects curve B at the intersection point C. After the intersection point C, the voltage delivered by the second power supply module 140 (illustrated by curve B2 downstream of point C) is higher than the voltage delivered by the first power supply module 130 (illustrated by curve A downstream of point C). The selection device 108 therefore selects the second power supply module 140 to supply voltage to the bearing controller 102. When it has exceeded the voltage delivered by the first power supply module 130, the voltage delivered by the second module decreases progressively over time (see the reference VI in FIG. 2) until it reaches the zero voltage V0. At this point, the power supply voltage delivered by the first and the second power supply module 130, 140 is zero.

The voltage delivered by the second power supply module 140 decreases over time, owing to the reduction of the speed of the synchronous motor 106 in freewheel mode until the motor stops.

The period of time during which the bearing controller 102 is supplied by the second power supply module may be between 1 s and 60 s, or more particularly between 5 s and 30 s. During this period, the voltage delivered to the bearing controller 102 is reduced over time until it reaches a minimum voltage Vmin. This power supply period is illustrated in FIG. 4, and corresponds to the “duty” state, which denotes a state in which the second power supply module 140 delivers the power to the bearing controller 102.

Starting from this minimum voltage Vmin, the ball bearings of the magnetic bearing 104, called “catcher bearings”, can take over and receive the motor shaft 110 of the synchronous motor 106. The motor shaft drops onto the ball bearings of the magnetic bearing 104 until the motor finally comes to a halt, without causing any damage to the bearing 104.

In one embodiment, the minimum DC voltage Vmin delivered by the second power supply module 140 before the motor shaft 110 comes to rest on the ball bearings of the magnetic bearing 104 may be between 60 V DC and 140 V DC, or preferably between 70 V DC and 120 V DC.

Preferably, this minimum voltage Vmin is delivered at a frequency of Fmin. The frequency Fmin may be between 60 Hz and 100 Hz. This frequency is the minimum frequency at which the bearing controller 102 can be supplied.

When the voltage delivered by the second power supply module 140 reaches V0 and becomes zero, this is followed by a rest period in which the bearing controller 102 can no longer be supplied by the second power supply module 140. This power supply period is shown in FIG. 4, and corresponds to the “rest” state, in which the second power supply device no longer supplies power to the bearing controller 102.

Preferably, the rest period is between 30 s and 160 s; more particularly, it is between 100 s and 140 s, or more precisely of the order of 120 s.

The reference VIII indicates the point where the failure of the first power supply module 130 has been remedied and the first power supply module can again supply power to the bearing controller 102.

Advantageously, the power supply system 100 according to the invention is configured to be used in a cycle gas compression system of a gas refrigeration and/or liquefaction system comprising a power supply system according to any of the embodiments described. The compression system may be a land-based facility or may be included in a maritime vessel such as a liquefied natural gas carrier.

It will be understood that many additional changes in the details, materials, steps and arrangements of parts, which have been herein described in order to explain the nature of the invention as expressed in the appended claims. Thus, the present invention is not intended to be limited to the specific embodiments in the examples given above.

1. A power supply system (100) for a magnetic bearing controller (102) of a permanent magnet synchronous motor (106), comprising:
a first power supply module (130), configured to be connected to a power grid and to supply voltage to the magnetic bearing controller (102),
a second power supply module (140) configured to supply voltage to the magnetic bearing controller (102), the voltage of the second power supply module (140) being drawn from the synchronous motor (106),
a device (108) for selecting the first power supply module (130) or the second power supply module (140) for supplying voltage to the magnetic bearing controller (102),
wherein
the second power supply module (140) is configured to deliver, in a nominal operating mode, a voltage lower than the voltage delivered by the first power supply module (130),
the second power supply module (140) is connected in parallel with the first power supply module (130) and upstream of the magnetic bearing controller (102),
the selection device (108) is configured to select the power supply module (130, 140) delivering the higher voltage to the magnetic bearing controller (102).

2. The system as claimed in claim 1, characterized in that the selection device (108) comprises a voltage rectifier element (108a, 108b).

3. The system as claimed in claim 1 or 2, characterized in that the second power supply module (140) is configured to be supplied with voltage by the motor (106):
by means of a speed controller (105) in nominal operating mode; and/or
by the motor acting as a generator when it is in freewheel mode.

4. The system as claimed in any of the preceding claims, characterized in that the selection device (108) comprises at least two ORing diodes (108c, 108d), the first ORing diode (108c) being positioned downstream of the first power supply module (130) and the second ORing diode (108d) being positioned downstream of the second power supply module (140), the first and second ORing diodes (108c, 108d) being arranged in parallel.

5. The system as claimed in any of the preceding claims, characterized in that the first power supply module (130) and/or the second power supply module (140) comprises a transformer (132, 142).

6. The system as claimed in any of the preceding claims, characterized in that the voltage accepted by the magnetic bearing controller (102) is between 70 V DC and 800 V DC, preferably between 100 V DC and 750 V DC.

7. The system as claimed in any of the preceding claims, characterized in that the second power supply module (140) is configured to deliver a minimum voltage of between 70 V DC and 120 V DC, preferably 100 V DC, to the magnetic bearing controller (102) at a frequency of between 60 Hz and 100 Hz, preferably 80 Hz.

8. The system according to any of the preceding claims, characterized in that it comprises a device (152) for monitoring the voltage delivered by the power supply modules.

9. The system as claimed in any of the preceding claims, characterized in that it comprises, downstream of the first power supply module (130) and the second power supply module (140), a capacitive filter (150) forming an energy storage means.

10. The system for compressing cycle gas of a gas refrigeration and/or liquefaction system, comprising a power supply system (100) as claimed in any of the preceding claims.

11. A method for supplying power to a magnetic bearing controller (102) of a permanent magnet synchronous motor (106), comprising:
a step of selecting (S1), by means of a selection device (108), a power supply module (130, 140) supplying the higher voltage to supply the magnetic bearing controller (102),
the selection being made between:
a first power supply module (130), configured to be connected to a power grid and to supply voltage to the magnetic bearing controller (120), and
a second power supply module (140), connected in parallel with the first power supply module (130), the voltage supplied by the second power supply module (140) being drawn from the synchronous motor (106),
the second power supply module (140) delivering, in a nominal operating mode, a voltage lower than the voltage delivered by the first power supply module (130),
a step of delivering a power supply (S2) wherein the magnetic bearing controller (102) is supplied by the power supply module (130, 140) selected by the selection device (108).

12. The method as claimed in claim 11, characterized in that the synchronous motor (106) acts as a generator when it is in freewheel mode.

13. The method as claimed in claim 11 or 12, characterized in that the second power supply module (140) supplies the magnetic bearing controller (102) during a period of between 1 s and 60 s, or more particularly between 5 s and 30 s.

14. The method as claimed in any of claims 11 to 13, characterized in that, when the second power supply module (140) supplies the magnetic bearing controller (102), the voltage delivered to the magnetic bearing controller (102) decreases over time until it reaches a minimum voltage.

15. The method as claimed in claim 14, characterized in that the minimum voltage delivered to the magnetic bearing controller (102) is between 70 V DC and 120 V DC, and has a frequency of between 60 Hz and 100 Hz.

16. The method as claimed in any of claims 11 to 15, characterized in that the supply of the magnetic bearing controller (102) by the second power supply module (140) is followed by a rest period in which the magnetic bearing controller (102) is not supplied by the second power supply module (140).

17. The method as claimed in claim 16, characterized in that the rest period is between 30 s and 160 s, more particularly between 100 s and 140 s, or even more precisely 120 s.
